(19) United States
(12) Patent Application Publication
(10) Pub. No.: US 2014/0380343 A1
(43) Pub. Date: Dec. 25, 2014

(54) METHOD AND APPARATUS FOR DOWNLOADING MULTI-EPISODE CONTENT

(71) Applicant: THOMSON LICENSING, Issy de Moulineaux (FR)

(72) Inventor: Alaleh Towhidi BAGHINI, San Marcos, CA (US)

(21) Appl. No.: 13/921,264

(22) Filed: Jun. 19, 2013

(51) Int. Cl. H04N 21/262; H04N 21/2543

(52) U.S. Cl. CPC H04N 21/26225; H04N 21/2543; H04N 21/26241
USPC 725/5

(57) ABSTRACT

A method for providing content to a viewer commences by first downloading, in response to viewer selection, at least one piece of content having multiple episodes, with each episode having a scheduled play out date. Thereafter, an actual play out date for each episode of the at least one piece of content is established based on viewer input such that the actual play out date for each episode does not occur earlier than the scheduled play out date. Lastly, the viewer will be billed upon the actual play out of each episode in an amount dependent on how long the actual play out date is delayed from the scheduled play out date.

### TECHNICAL FIELD

This invention relates to a method and apparatus for downloading multi-episode content.

### BACKGROUND ART

Today, those who subscribe to a network content delivery service provider can receive a wide variety of programming choices. Often a subscriber of a cable television, satellite television, or Internet Over-the-top television service provider will receive a “basic” package of certain content for a given price, usually in the form of a monthly subscription fee. Most network content delivery service providers offer “premium” content from content providers such as HBO, Showtime, Starz, and Cinemax, usually for an additional monthly fee. Such content providers offer premium content, e.g., movies, concerts, documentaries and/or sporting events which a viewer can watch during a single viewing (hence, “single” episode content.) In addition, such content offer can offer premium content in the form of a series of individual episodes (i.e., “multiple” episode content). Examples of such multi-episode content include Boardwalk Empire and Game of Thrones produced by HBO and The Borgias produced by Showtime. Presently, a viewer who wants to watch individual episodes of such multi-episode content must either subscribe to that content provider for all programming Alternatively, a subscriber can wait until the content provider has released the desired multi-episode content on DVD and then purchase individual episodes (if offered) or the DVD(s) containing all of the episodes.

Thus, a need exists for a technique that facilitates viewing of multi-episode content without the need to subscribe to all premium content or buy recorded copies of such content.

### BRIEF SUMMARY OF THE PRESENT PRINCIPLES

Briefly, in accordance with a preferred embodiment of the present principles, a method for providing content to a viewer commences by first downloading, in response to viewer selection, at least one piece of content having multiple episodes, with each episode having a scheduled play out date. Thereafter, an actual play out date for each episode of the at least one piece of content is established based on viewer input such that the actual play out date for each episode does not occur earlier than the scheduled play out date. Lastly, the viewer will be billed upon the actual play out of each episode in an amount dependent on how long the actual play out date is delayed from the scheduled play out date. In practice, the viewer will pay more for play out of an episode on the scheduled play out date, while the viewer will pay less when the actual play out date lags the scheduled play out date by a few days or even a week.

### BRIEF SUMMARY OF THE DRAWINGS

FIG. 1 depicts a block schematic diagram of a system for practicing the content downloading technique of the present principles;

FIG. 2 depicts a block schematic diagram of a program receiving device comprising part of the system of FIG. 1;

FIG. 3 depicts a screen-shot displayed in connection with content down-loading in accordance with the present principles.

### DETAILED DESCRIPTION

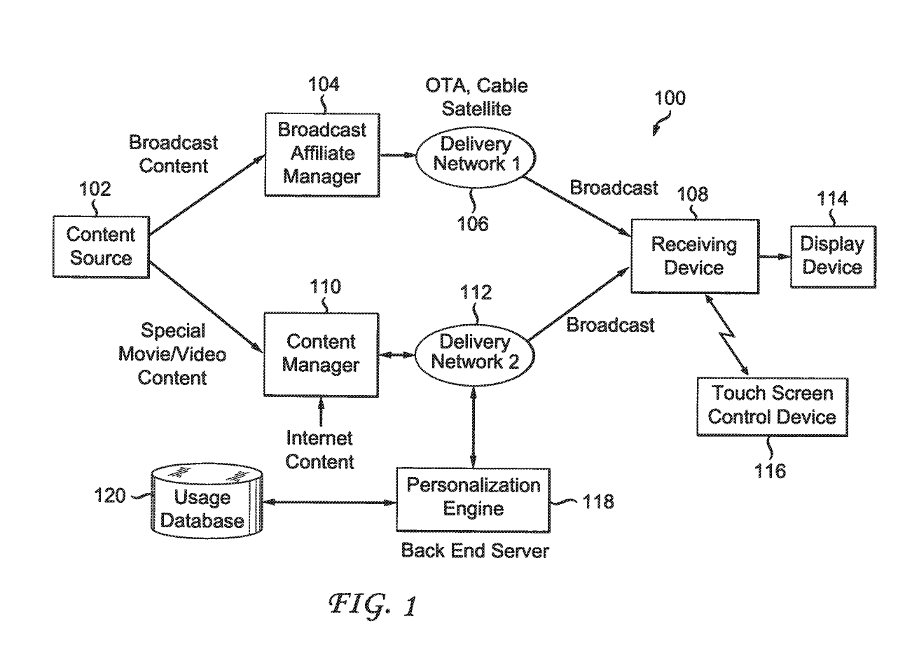

FIG. 1 depicts a block diagram of a system 100 for delivering one or more pieces of content to viewer (not shown). Each piece of content typically comprises an audio-visual file, for example a movie or television program that originates from a content source 102 which can deliver content in at least two forms. For example, the content source 102 can deliver content in the form of “broadcast” content of the type formatted for terrestrial broadcast by a broadcast affiliate manager 104, typically a national television broadcast network operated by American Broadcasting Company (ABC), National Broadcasting Company (NBC), Columbia Broadcasting System (CBS), etc. The broadcast affiliate manager 104 can collect and store the content and can schedule delivery of the content over a delivery network 106, which can include a wired or wireless communications network or a combination of over-the-air (OTA), cable television and/or satellite communication networks.

The content source 102 can also deliver content in a special form, such as premium or pay-per-view content otherwise not provided to the broadcast affiliate manager 104. For example, such special content can include first run movies or a multi-episode series offered to viewers in response to their request. The content source 102 provides such special content to a content manager 110, which can comprise a service provider, such as an Internet website, affiliated with a program provider, broadcast service, or network delivery service. The content manager 110 can also incorporate Internet files for delivery with one or more special content. In practice, the content manager 110 delivers special content (and associated Internet files) over a separate delivery network 112, which can include a Wide-Area Network (WAN), Local-Area Network (LAN) and/or high-speed broadband communications network, including, but not limited to, the Internet. Note that the content provided by the broadcast affiliate manager 104 could undergo delivery using all or part of delivery network 112 and content from the content manager 110 could undergo delivery using all or part of delivery network 106. In addition, the delivery of content could occur directly via the network 112 without the need for the content manager 110.

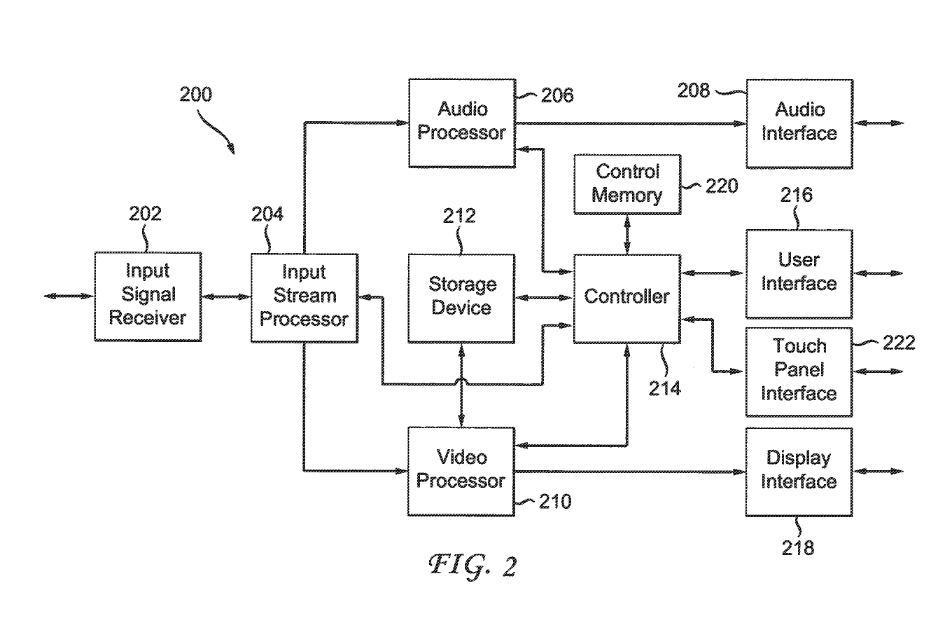

At a local premise, such as a home or the like, a viewer will make use of a receiving device 108, described in greater detail with respect to FIG. 2, to receive content via the networks 106 and 112 for processing and subsequent display on a display device 114, such as a television set or the like. The receiving device 108 can take many forms, such as a set-top box, gateway, modem or the like, the functionality of which can be embodied in devices such as a digital video recorder, personal computer, television set, etc. and may be embodied as a set top box/digital video recorder (DVR), a gateway, a modem, etc. Further, the program receiving device 108 may act as entry point, or gateway, for a home network system that includes additional devices configured as either client or peer devices in the home network (not shown).

The receiving device 108 processes the content received via the networks 106 and 112 and separates the content based on viewer preferences and commands. The program receiving device 108 can include a storage device, such as a hard drive or optical disk drive (not shown), for content recording and playback. The receiving device 108 can interface to a second screen in the form of a touch screen control device 116 to allow the viewer to control both the receiving device 108 and the display device 114. The touch screen control device 116 also has the capability displaying video, including, but not limited to, viewer data entries as well as a portion of the content delivered to the display device 114.

In accordance with an aspect of the present principles, the touch screen control device 116 also has the capability of displaying to the viewer information indicative of content received by the program receiving device 108. In particular, the touch screen control device 116 has the capability to display content choices available to the viewer, including but not limited to multi-episode content. Using the touch screen control device 116 of FIG. 1, the user can select a particular piece of content having multiple episodes, each episode having a scheduled play out date established by the content source 102. For example, if the viewer has selected a series such as Boardwalk Empire produced by HBO, each episode might have a scheduled play out date on a particular Sunday evening, such that the episodes play out in sequence on successive Sunday evenings. Having selected a particular piece of content with multiple episodes, the viewer will then make use of touch screen display device 116 to a select date for actual play out of each episode, the actual play out date being on or after the scheduled play out date for that episode. In other words, the viewer cannot select an actual play out date earlier than the scheduled play out date for that episode.

The provider of the particular piece of multi-episode content selected by the viewer will set a billing price for the user based on the delay between the scheduled play out date and the actual play out date selected by the viewer. For example, if the viewer has selected an actual play out date for a given episode coinciding with the scheduled date for play out, the viewer pay a maximum charge (say $9.99) for that episode. However, if the viewer chooses an actual play out date day or longer after the scheduled play out date, the viewer would receive a discount, and might get billed only $6.99 for example. If the viewer chooses an actual play out date a week or more after the scheduled play out date, the viewer would receive a greater discount, and might get billed only $3.99 for example

In practice, the touch screen control device 116 can take a variety of forms. For example, the touch screen control device 116 could take the form of a tablet device, such as the Apple I-Pad, or Samsung Galaxy Note tablet. Alternatively, the touch screen control device 116 could take the form of a smart phone or lap-top computer or any other similar device that can send and receive data as well as provide a display of such data. The touch screen control device 116 typically interfaces to the program receiving device 108 which can include one or more of any well-known wireless transmission mechanisms including, but not limited to infra-red (IR) or frequency (RF) communications and can make use standard protocols such as infra-red data association (IRDA) standard, Wi-Fi, or Bluetooth wireless protocols, as example. The system 100 can include a back end server 118 and a usage database 120. The back end server 118 includes a personalization engine that analyzes the usage habits of viewers sand makes recommendations based on those habits. The usage database 120 stores viewer data indicative of habits and also stores viewer profiles generated by the server 118.

Although the viewer will typically make use of the touch screen control device 116 to select multi-episode content and schedule actual play out dates for the episodes, the viewer could make use other mechanisms to accomplish these tasks. For example, the viewer could make use of the of a remote control (not shown) associated with the display device 114 of FIG. 1 to accomplish to select multi-episode content and schedule actual play out dates for the episodes, thus obviating the need for the touch screen control device 116 to serve this purpose.

FIG. 2 depicts a block schematic diagram of an exemplary embodiment of the receiving device 108 of FIG. 1. As illustrated in FIG. 2, the receiving device 108 includes an input signal receiver 202 that receives programs via the networks 106 and 112 shown in FIG. 1. The input signal receiver 202 can comprise one of several known receiver circuits used for receiving, demodulating and decoding received content. An input stream processor 204 receives the decoded content and performs the final signal selection and processing, including separation of video from audio in the decoded content. The input stream processor 204 supplies the audio to an audio processor 206, which generates an audio signal for receipt by an audio interface 208 that provides the signal to the display device 114 of FIG. 1, or other device (not shown) for audio reproduction. Typically, the audio interface 208 generates an analog audio signal. Alternatively, the audio interface 208 could generate a digital signal. Additionally, the audio processor 206 supplies audio signals to a storage device 212 for storage. The input stream processor 204 also provides a video output signal to a video processor 210, which undertakes signal conversion to provide a video signal of the appropriate format for storage in the storage device 212 and for display. A display interface 218 interfaces the video processor 210 to the display device 114 of FIG. 1.

The storage device 212, which stores content audio and video, allows later retrieval and playback of the content under the control of a controller 214 in accordance with commands received by the viewer through a viewer interface 216 and/or a touch panel interface 222 which provides an interface to a touch panel (not shown) separate from, or integrated with the display device 114 of FIG. 1. The viewer interface 216 provides the mechanism by which the touch screen control device 116 of FIG. 1 interfaces to the controller 214.

The storage device 212 can comprise be a hard disk drive, one or more large capacity integrated electronic memories, such as static RAM (SRAM), or dynamic RAM (DRAM), or an interchangeable optical disk storage system such as a compact disk (CD) drive or digital video disk (DVD) drive.

The controller 214 controls the operation of the receiving device 108 and to that end, the controller has bus interconnection to the input stream processor 202, the audio processor 206, the video processor 210, the storage device 212, the viewer user interface 216 and the touch panel interface 222. The controller 214 manages the conversion process for converting the input stream signal into a format appropriate for storage on the storage device 212 or for display. The controller 214 also manages the retrieval and playback of stored programs.

The controller 214 also has a bus interconnection to a control memory 220 (e.g., a volatile or non-volatile memory, including RAM, SRAM, DRAM, ROM, programmable ROM (PROM), flash memory, electronically programmable ROM (EPROM) , electronically erasable programmable ROM (EEPROM), etc.) for storing information and instruction code for controller 214. The control memory 220 can also store a database of elements, such as graphic elements for generating a graphical user interface for display to the viewer.

In accordance with the present principles, the controller 214 of FIG. 2 will provide information for display to the viewer, typically via the display device 114 and/or the touch screen control device 116 (both of FIG. 1) indicative of content choices available to the viewer. The viewer then will select one or more pieces of content, possibly including a piece of content having multiple episodes. Upon selection of a piece of content having multiple episodes, the controller 214 will provide information for display indicative of the scheduled play out dates for the episodes, as established by the content provider. The viewer will then select actual dates of play out of the episodes, whereupon the controller will provide information for display indicative of the actual play out dates, as well as the billing charges incurred by the viewer for play out on the actual dates selected by the viewer.

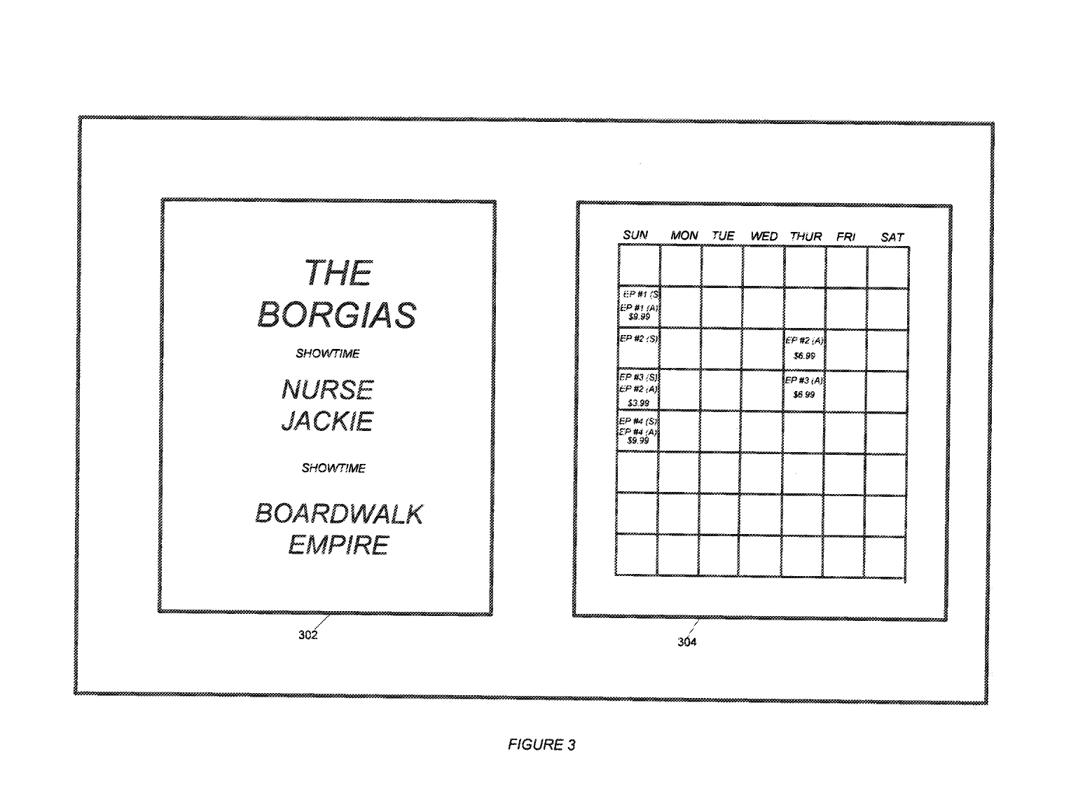

FIG. 3 depicts a screen display 300 provided by one of the display device 108 or the touch screen control device 114 of FIG. 1 (or possibly another device) which graphically illustrates the content downloading technique of the present principles. The screen display 300 typically contains two separate screen portions 302 and 304 appearing on the left and right-hand sides of FIG. 3 although their positions could easily be reversed. The screen portion 302 depicts available content selections, which in the illustrated embodiment of FIG. 3 comprise The Borgias (available from Showtime), Nurse Jackie (available from Showtime), and Boardwalk Empire (available from HBO). If the viewer has selected The Borgias, then the second screen portion 302 will indicate such a selection by displaying The Borgias in larger case as compared to the other content selections. Although not shown, other mechanisms, such as highlighting, differences in font shape, texture and style, for example could serve to differentiate the selected content from the content choices not selected.

When the selected content contains multiple episodes, the second screen portion will display the dates the content provider has scheduled for display of such episodes. In practice, the second screen portion 302 will typically take the form of a calendar showing the scheduled display dates. For the selected content (The Borgias), the content provider has scheduled episodes #1-#4 on consecutive Sundays, beginning with the second Sunday in the month. Thus, the box corresponding to the second Sunday in the month bears the legend “episode #1 (S)”, whereas the subsequent Sunday calendar entries contain similar legends for the subsequent episodes. As discussed previously, the viewer can select the date he or she actually wants to view each episode, provided that the actual viewing date for that episode lies on or after the scheduled display date for the same episode. For example, the legend “episode #1 (A)” will reside in the calendar entry on the date the viewer has selected to actually view episode #1.

The date when the viewer selects to actually view the episode will dictate the charge billed to the viewer for that viewed episode. As discussed above, the content provider typically charges the highest cost when the viewer selects the actual viewing date to coincide with the scheduled viewing date of that episode. Thus, in the example depicted in FIG. 3, having selected to view episode #1 on the same Sunday as the scheduled viewing date, the viewer will pay $9.99. In practice, the content provider will typically offer a discount if the viewer selects the actual viewing after the scheduled viewing date, with a longer delay earing a greater discount. Thus, when the viewer selects to view episode #1 several days after the scheduled viewing date for that episode, the viewer will pay $6.99. If the viewer delays by a week or more, then the viewer will pay less, for example $3.99.

The foregoing describes a technique for downloading multi-episode content to viewer.

1. A method for providing content selected by a viewer and billing information associated with viewing the content selected by the viewer on a viewer-selected date, comprising the steps:
downloading, in response to viewer selection, at least one piece of content having multiple episodes, with each episode having a separate scheduled playout date;
establishing an actual play out date for each episode based on viewer selection such that the actual play out date for each episode does not occur earlier than the separate scheduled play out date for said each episode; and
providing billing information to the viewer associated with viewing the content on the actual date selected by the viewer following viewer selection of the at least one piece of content and the actual date selected for playout of the one piece of content, the cost for playout varying in an amount dependent on how long the actual playout date of said each episode is delayed from the separate scheduled play out date for said each episode.

2. The method according to claim 1 wherein the viewer is billed less for a longer delay between the actual play out date and the separate scheduled play out date.

3. The method according to 1 claim further including the step of displaying the separate scheduled play out dates and actual play out dates in a calendar format.

4. The method according to claim 3 further including the step of displaying available content choices for viewer selection side-by-side with the calendar format display of the separate scheduled play out dates and actual play out dates.

5. The method according to claim 3 further including the step of displaying the amount billed to the user along with the display of the separate scheduled play out dates and actual play out dates in a calendar format.

6. An apparatus for providing content selected by a viewer and billing information associated with viewing the content selected by the viewer on a viewer selected date, comprising:
a stream processor for receiving content selected by the viewer for viewing, the content containing multiple episodes, with each episode having a separate scheduled play out date; and
a controller for establishing an actual play out date for each episode based on viewer selection such that the actual play out date for each episode does not occur earlier than the separate scheduled play out date for said each episode and for providing billing information to the viewer indicative of a cost for play out of each episode on the actual playout date selected by the viewer following viewer selection of the at least one piece of content and the actual date selected for playout of the one piece of content, the cost varying in an amount dependent on how long the actual play out date of said each episode is delayed from the separate scheduled play out date for said each episode.

7. The apparatus according to claim 6 wherein the viewer is billed less for a longer delay between the actual play out date and the separate scheduled play out date for said each episode.

8. The apparatus according to claim 6 wherein the controller further provides information to display the separate scheduled play out dates and actual play out dates in a calendar format.

9. The apparatus according to claim 8 wherein the controller further provides information to display content choices for viewer selection side-by-side with display the separate scheduled and actual play out dates in calendar format.

10. The apparatus according to claim 9 wherein the controller further provides information to display the billing amount to the user along with the display of the separate scheduled play out dates and actual play out dates in a calendar format.
